(19) United States
(12) Patent Application Publication
(10) Pub. No.: US 2019/0080069 A1
(43) Pub. Date: Mar. 14, 2019

(54) OPERATION PERMISSION AUTHENTICATION DEVICE

(71) Applicant: TOYOTA JIDOSHA KABUSHIKI KAISHA, Toyota-shi (JP)

(72) Inventor: Kunihito SATO, Mishima-shi (JP)

(73) Assignee: TOYOTA JIDOSHA KABUSHIKI KAISHA, Toyota-shi (JP)

(21) Appl. No.: 16/106,327

(22) Filed: Aug. 21, 2018

(30) Foreign Application Priority Data
Sep. 11, 2017 (JP) 2017-173949

(51) Int. Cl. G06F 21/32; G09B 19/16; B60R 25/25

(52) U.S. Cl. CPC G06F 21/32; B60R 25/25; G09B 19/167

(57) ABSTRACT

The device includes: a storage unit configured to store biological information on an autonomous driving permitted person; a driver qualification information acquisition unit configured to acquire driver qualification information; a biological information acquisition unit configured to acquire biological information on the occupant; and an authentication unit configured to authenticate whether or not to permit the occupant to operate the autonomous driving of the vehicle based on the driver qualification information on the occupant acquired by the driver qualification information acquisition unit and a result of collation between the biological information on the autonomous driving permitted person stored in the storage unit and the biological information on the occupant.

### TECHNICAL FIELD

The present disclosure relates to an operation permission authentication device of autonomous driving.

### BACKGROUND

In the related art, Japanese Unexamined Patent Publication No. 2016-130091 is known as a technical document relating to operation permission for autonomous driving. In this publication, if start of the autonomous driving is instructed, when an existence of a driver's license is confirmed by a driver's license card reader, the autonomous driving of the vehicle is permitted to be performed.

### CROSS-REFERENCE TO RELATED APPLICATION

This application claims the benefit of priority from Japanese Patent Application No. 2017-173949, filed Sep. 11, 2017, the entire contents of which are incorporated herein by reference.

### SUMMARY

However, in the device in the related art described above, only the driver qualification is confirmed, and it is not sufficiently confirmed whether or not occupants are persons who can be permitted for the autonomous driving of the vehicle. For this reason, it is required to perform an appropriate authentication on the operation permission for the autonomous driving.

Therefore, in the present technical field, it is desired to provide an operation permission authentication device that can appropriately authenticate the operation permission for the autonomous driving.

According to an aspect of the present disclosure, there is provided an operation permission authentication device configured to perform authentication for operation permission for autonomous driving of a vehicle, the device including: a storage unit configured to store biological information on an autonomous driving permitted person; a driver qualification information acquisition unit configured to acquire driver qualification information on an occupant in a driver's seat of the vehicle; a biological information acquisition unit configured to acquire biological information on the occupant based on a result of measurement performed by a seat sensor provided in the driver's seat or a contact sensor provided against the driver's seat; and an authentication unit configured to authenticate whether or not to permit the occupant to operate the autonomous driving of the vehicle based on the driver qualification information on the occupant acquired by the driver qualification information acquisition unit and a result of collation between the biological information on the autonomous driving permitted person stored in the storage unit and the biological information on the occupant acquired by the biological information acquisition unit.

According to the operation permission authentication device in the aspect of the present disclosure, not only the driver qualification information on the occupant in the driver's seat but also the biological information on the occupant in the driver's seat is acquired from the result of measurement of the seat sensor and contact sensor, and then, the operation permission for the autonomous driving is authenticated based on the result of collation with the biological information on the autonomous driving permitted person. Therefore, even if the occupant is misidentified due to lending/borrowing of the driver's license, by referring to the result of collating with the biological information, it can be avoided to give an operation permission for the autonomous driving to improper occupants that are not autonomous driving permitted persons, and thus, it is possible to appropriately authenticate the operation permission for the autonomous driving.

The operation permission authentication device according to the aspect of the present disclosure may further include: a student data storage unit configured to store student data of tutorial students for the autonomous driving; a tutorial necessity determination unit configured to determine a necessity for the occupant to take the tutorial based on the biological information on the occupant acquired by the biological information acquisition unit and the student data of the tutorial students stored in the student data storage unit; and a notification unit configured to notify the occupant of a result of determination performed by the tutorial necessity determination unit.

According to this operation permission authentication device, if it is determined by the tutorial necessity determination unit that it is necessary for the occupant in the driver's seat to take the tutorial for the autonomous driving, the notification unit can notify the occupant of the fact that it is necessary to take the tutorial for the autonomous driving. Therefore, it is possible to prevent the occupant from using the autonomous driving of the vehicle without fully understanding the autonomous driving.

In the operation permission authentication device according to the aspect of the present disclosure, the authentication unit may be configured not to permit the operation of the autonomous driving until the occupant completes taking the tutorial if it is determined by the tutorial necessity determination unit that it is necessary for the occupant to take the tutorial for the autonomous driving.

According to the operation permission authentication device, if it is determined that it is necessary for the occupant in the driver's seat to take the tutorial for the autonomous driving, the occupant is not permitted to operate the autonomous driving until completion of the tutorial. Therefore, it can be avoided to give the operation permission for the autonomous driving to the occupant who doesn't fully understand the autonomous driving.

In the operation permission authentication device according to the aspect of the present disclosure, the tutorial necessity determination unit may be configured to determine the necessity for the occupant to take the tutorial based on the result of collation between the biological information on the autonomous driving permitted person stored in the storage unit and the biological information on the occupant acquired by the biological information acquisition unit, the student data of the tutorial students stored in the student data storage unit, and version upgrade information on the tutorial.

According to the operation permission authentication device, the necessity for the occupant to take the tutorial for the autonomous driving is determined based on the version upgrade information on the tutorial. Therefore, the occupant can appropriately know that it is necessary to take the tutorial for the autonomous driving due to the version upgrade of the tutorial.

As described above, according to the operation permission authentication device in the aspect of the present disclosure, it is possible to appropriately authenticate the operation permission for the autonomous driving.

### BRIEF DESCRIPTION OF THE DRAWINGS

FIG. 1 is a block diagram illustrating an operation permission authentication device in an embodiment.

FIG. 2 is a flowchart illustrating an operation permission authentication processing performed by the operation permission authentication device.

### DETAILED DESCRIPTION

Hereinafter, an embodiment of the present disclosure will be described with reference to the drawings.

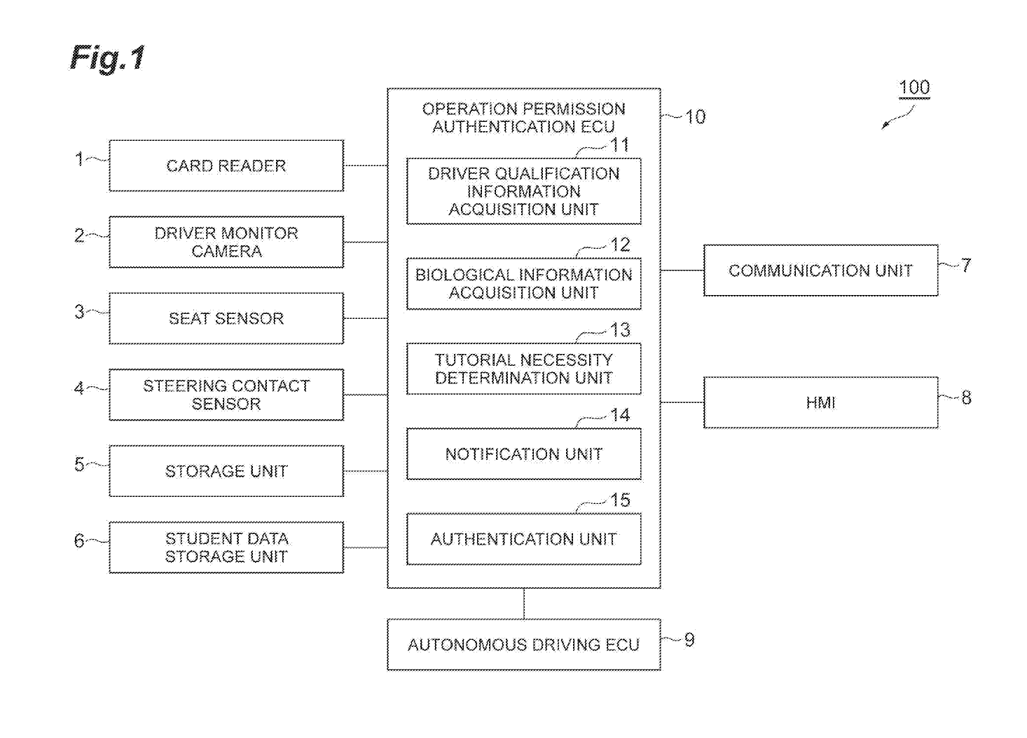

FIG. 1 is a block diagram illustrating an operation permission authentication device in the embodiment. The operation permission authentication device 100 illustrated in FIG. 1 is a device that performs authentication of operation permission for autonomous driving. The operation permission authentication device 100 is mounted on a vehicle capable of autonomous driving, for example. The autonomous driving is a vehicle control in which the driver causes the host vehicle to autonomously travel without performing a driving operation.

The authentication of the operation permission for the autonomous driving is performed on the driver of the vehicle. The driver in the present embodiment means an occupant seated in the driver's seat and does not need to necessarily drive the vehicle. The driver may be an occupant (a user) in the driver's seat who only uses the vehicle traveling by the autonomous driving without driving the vehicle at all. The driver's seat is a seat where the vehicle's driving operation can be possibly performed in the vehicle.

### Configuration of Operation Permission Authentication Device

As illustrated in FIG. 1, the operation permission authentication device 100 includes an operation permission authentication electronic control unit (ECU) 10. The operation permission authentication ECU 10 is an electronic control unit including a central processing unit (CPU), read only memory (ROM), random access memory (RAM), a controller area network (CAN) communication network, and the like. In the operation permission authentication ECU 10, for example, various functions are realized by loading a program stored in the ROM into the RAM and executing the program loaded in the RAM by the CPU. The operation permission authentication ECU 10 may be configured with a plurality of electronic units.

A card reader 1, a driver monitor camera 2, a seat sensor 3, a steering contact sensor 4, a storage unit 5, a student data storage unit 6, a communication unit 7, an HMI 8 and an autonomous driving ECU 9 are connected to the operation permission authentication ECU 10.

The card reader 1 is a device provided on a dashboard of the vehicle, and is a device for reading the driver's license information. A method of reading the driver's license information is not particularly limited. The card reader 1 may recognize a content of the driver's license by image recognition, or may be able to read information from an integrated circuit (IC) chip in a built-in IC type driver's license.

The driver monitor camera 2 is provided in front of the driver's seat on a cover of a steering column of the vehicle and images a face of the driver. A plurality of driver monitor cameras 2 may be provided other than the cover of the steering column, and may image the driver from a plurality of directions. The driver monitor camera 2 transmits a face image of the driver to the operation permission authentication ECU 10.

The seat sensor 3 is a device embedded in the seating face portion of the driver's seat, and is a device that measures the weight of the occupant seated in the driver's seat. As the seat sensor 3, for example, a piezoelectric element can be used. The seat sensor 3 transmits weight information on the weight of the driver to the operation permission authentication ECU 10 as a result of measurement. A plurality of seat sensors 3 may be provided so as to measure the driver's weight distribution with respect to the seating face of the driver's seat. In this case, the weight information also includes driver's weight distribution information.

The steering contact sensor 4 is a device provided on a surface of the steering wheel of the vehicle, and is a device that detects fingerprints of the driver by the driver grasping the device. As the steering contact sensor 4, a well-known fingerprint detector can be used. The steering contact sensor 4 transmits fingerprint information on the fingerprint of the driver to the operation permission authentication ECU 10 as a result of measurement.

The steering contact sensor 4 may detect a vein of a finger or a hand instead of the driver's fingerprint. In this case, the steering contact sensor 4 transmits vein information on the vein of the driver to the operation permission authentication ECU 10.

A storage unit 5 is a storage device that stores biological information on autonomous driving permitted persons. The autonomous driving permitted person means a person to whom the autonomous driving of the vehicle is permitted. The autonomous driving permitted person is set in advance (registered) for each vehicle capable of autonomous driving. The autonomous driving permitted person is, for example, an owner of the vehicle and a person who is permitted to use the vehicle by the owner. The method of registering the autonomous driving permitted person is not particularly limited.

The biological information on the autonomous driving permitted person is information used for authenticating the autonomous driving permitted person. The biological information includes the face image information, the weight information (including the weight distribution information), the fingerprint information, and the like.

The storage unit 5 does not need to be separated from the operation permission authentication ECU 10 but may be provided in the operation permission authentication ECU 10. Alternatively, the storage unit 5 may be provided in an external server capable of communicating with the vehicle.

The student data storage unit 6 is a storage device that stores student data of tutorial students for the autonomous driving. The tutorial for the autonomous driving is a tutorial taken by the occupant who uses the vehicle capable of autonomous driving in order to understand the autonomous driving. In the tutorial for the autonomous driving, for example, descriptions of the autonomous driving and actions to be taken when the autonomous driving falls into a situation of inability to continue are explained.

The student data is data of the students who take the tutorial for the autonomous driving. The student data also includes the biological information on the students. The student data includes information on the version of the tutorial taken by the students. The information on the version of the tutorial is information for identifying how many times the tutorial is revised when taken by the student. The student data may be associated with the autonomous driving permitted person. The student data may include version upgrade information that includes a fact that the version has been updated and date and time of updating, and student information on the tutorial corresponding to the version.

The student data storage unit 6 does not need to be separated from the operation permission authentication ECU 10 but may be provided in the operation permission authentication ECU 10. The student data storage unit 6 may be provided in the external server capable of communicating with the vehicle. The student data storage unit 6 may be integrated with the storage unit 5.

The communication unit 7 acquires various kinds of information via a wireless network (for example, the Internet, vehicle information and communication system (VICS®), or the like). The communication unit 7 may acquire road traffic information by communicating with a computer in a facility such as an information management center for managing traffic information. The communication unit 7 may acquire various kinds of information through road-to-vehicle communication with a roadside transceiver (for example, an optical beacon, an intelligent transport systems (ITS) spot, and the like) provided at the side of a road.

The HMI 8 is an interface that performs inputting and outputting of the information between the operation permission authentication device 100 and the occupant (not limited to the driver). The HMI 8 includes, for example, an input unit such as a button, a touch panel, and the like, and an output unit such as a display, a speaker, and the like. The HMI 8 outputs an image on the display and outputs a voice from the speaker according to a control signal from the operation permission authentication ECU 10.

The autonomous driving ECU 9 is mounted on the host vehicle and is an electronic control unit for performing the autonomous driving of a host vehicle. The autonomous driving ECU 9 may be configured with a plurality of electronic units. A part of the functions of the autonomous driving ECU 9 may be performed by a server that can communicate with the host vehicle.

The autonomous driving ECU 9 generates a travel plan along a target route set in advance based on information on a position of the host vehicle measured by a vehicle-mounted GPS receiver, map information in a map database, a surrounding environment (the position of another vehicle, or the like) of the host vehicle recognized from a result of measurement performed by a vehicle-mounted camera and a radar sensor (a millimeter wave radar or a LIDAR), and a vehicle state (vehicle speed, a yaw rate, and the like) recognized from a result of measuring performed by vehicle-mounted internal sensors (a vehicle speed sensor, a yaw rate sensor, and the like). The target route is set by the occupant of the host vehicle or a well-known navigation system. The navigation system in this case may be integrated with the autonomous driving ECU 9.

The autonomous driving ECU 9 performs the autonomous driving according to the travel plan. The autonomous driving ECU 9 performs the autonomous driving by transmitting a control signal to actuators of the host vehicle (an engine actuator, a steering actuator, a brake actuator, or the like). The autonomous driving ECU 9 can generate a travel plan and perform the autonomous driving using a well-known method.

Next, a functional configuration of the operation permission authentication ECU 10 will be described. As illustrated in FIG. 1, the operation permission authentication ECU 10 includes a driver qualification information acquisition unit 11, a biological information acquisition unit 12, a tutorial necessity determination unit 13, a notification unit 14, and an authentication unit 15.

The driver qualification information acquisition unit 11 acquires driver qualification information on the driver of the vehicle based on the driver's license information read by the card reader 1. The driver qualification information acquisition unit 11 may check the authenticity of the driver's license by performing a process of referring the driver's license information to a server or the like of the public organization via the wireless network using the communication unit 7.

The biological information acquisition unit 12 acquires the biological information on the driver of the vehicle based on the face image of the driver imaged by the driver monitor camera 2, the weight information on the driver measured by the seat sensor 3, and the fingerprint information on the driver detected by the steering contact sensor 4. The biological information acquisition unit 12 acquires the face image information, the weight information, the fingerprint information, and the like as the biological information on the driver.

The tutorial necessity determination unit 13 determines the necessity for the driver to take the tutorial for the autonomous driving based on the biological information on the driver acquired by the biological information acquisition unit 12 and the student data of the tutorial students stored in the student data storage unit 6. The tutorial necessity determination unit 13 determines the necessity for the driver to take the tutorial for the autonomous driving by collating the biological information on the driver with the biological information on the student.

Specifically, if the driver is a student who has taken the latest version of the tutorial, the tutorial necessity determination unit 13 determines that it is unnecessary for the driver to take the tutorial. If the driver is not a student who has taken the latest version of the tutorial, the tutorial necessity determination unit 13 determines that it is necessary for the driver to take the tutorial. Even if the driver is a student who has not taken the latest version of the tutorial, when the driver is taking a version of the tutorial allowable at current time, the tutorial necessity determination unit 13 may determine that it is unnecessary for the driver to take the tutorial.

The notification unit 14 notifies the driver of a result of determination performed by the tutorial necessity determination unit 13. If it is determined by the tutorial necessity determination unit 13 that it is necessary for the driver to take the tutorial, the notification unit 14 notifies the driver of the necessity of taking the tutorial. The notification unit 14 may inform the driver of the version upgrade information on the tutorial.

The notification unit 14 may have a function of providing the driver with the latest version of tutorial for the autonomous driving if the driver is notified of the fact that it is necessary to take the tutorial. The notification unit 14 may download the latest version of the tutorial for the autonomous driving from the wireless network via the communication unit 7 and provide the driver with the tutorial by displaying the image and outputting the sound. The notification unit 14 updates the student data in the student data storage unit 6 if the driver takes tutorial for the autonomous driving. In addition, the notification unit 14 may perform various notifications regarding the operation permission for the autonomous driving.

The authentication unit 15 determines whether or not to perform the authentication of the operation permission for the autonomous driving to the driver based on the driver qualification information on the driver acquired by the driver qualification information acquisition unit 11, the biological information on the driver acquired by the biological information acquisition unit 12, the biological information on the autonomous driving permitted person stored in the storage unit 5, and the result of determination performed by the tutorial necessity determination unit 13.

Specifically, the authentication unit 15 determines whether or not the driver has a driver qualification of the vehicle based on the driver qualification information on the driver. The authentication unit 15 collates the biological information on the driver acquired by the biological information acquisition unit 12 with the biological information on the autonomous driving permitted person stored in the storage unit 5. The authentication unit 15 determines whether or not the driver is an autonomous driving permitted person based on the result of collation between the biological information on the driver with the biological information on the autonomous driving permitted person.

If the biological information on the driver matches the biological information on the autonomous driving permitted person, the authentication unit 15 determines that the driver is the autonomous driving permitted person. Even if the biological information on the driver does not exactly match the biological information on the autonomous driving permitted person, the authentication unit 15 may determine that the driver is the autonomous driving permitted person. Even if there is a difference between the weight of the driver and the weight of the autonomous driving permitted person, for example, if the driver's face image and the fingerprint information on the driver matches those of the autonomous driving permitted person and the difference between the weight of the driver and the weight of the autonomous driving permitted person is within an allowable range set in advance, the authentication unit 15 may determine that the driver is the autonomous driving permitted person.

Even if the driver is the autonomous driving permitted person, if it is determined by the tutorial necessity determination unit 13 that it is necessary for the driver to take the tutorial, the authentication unit 15 does not permit the operation of the autonomous driving until the driver completes taking the tutorial.

If it is determined by the tutorial necessity determination unit 13 that it is unnecessary for the driver to take the tutorial and if the driver is the autonomous driving permitted person, the authentication unit 15 checks whether or not a passcode input is set. The passcode is a code for releasing the operation permission for the autonomous driving from being locked. If the passcode input is set, usually, the operation permission for the autonomous driving is locked by the passcode. For example, any type of the passcode can be set by the owner of the vehicle.

If the passcode input is set, the authentication unit 15 requests the driver to input the passcode. The authentication unit 15 makes the request by at least one of image display and audio output via the HMI 8. The driver inputs the passcode by operating the touch panel or the like of the HMI 8. If the passcode is input, the authentication unit 15 performs authentication for permitting the driver to operate the autonomous driving of the vehicle. The authentication unit 15 transmits an operation permission signal for the autonomous driving to the autonomous driving ECU 9.

### Operation Permission Authentication Processing Performed by Operation Permission Authentication Device

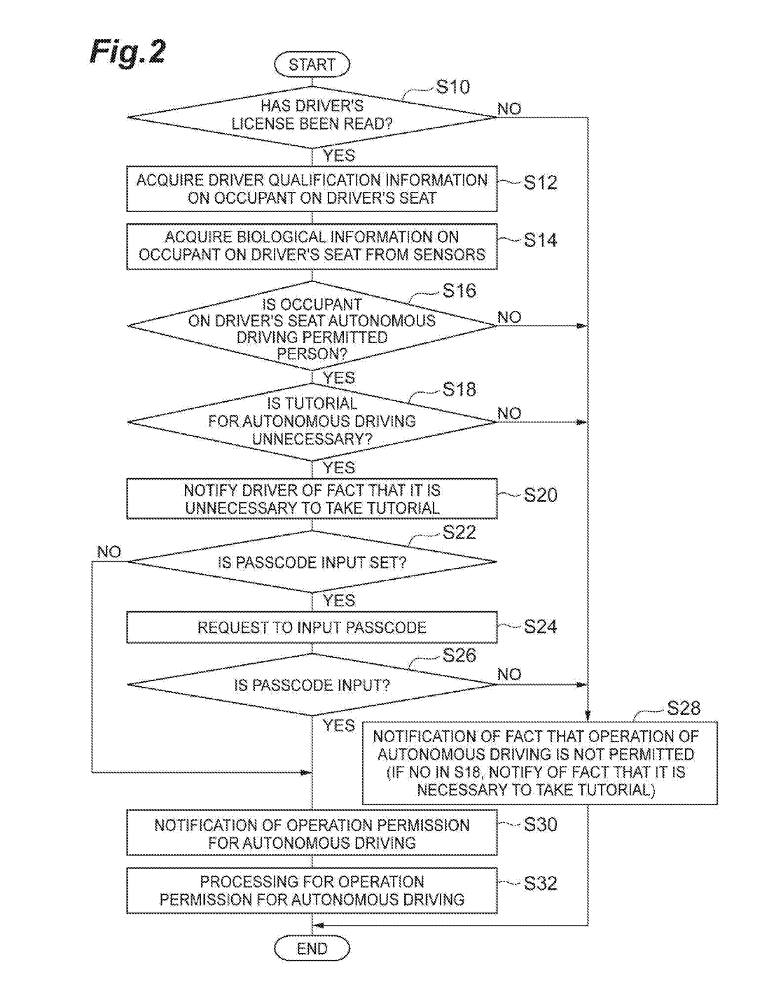

Next, the operation permission authentication processing performed by the operation permission authentication device 100 will be described with reference to FIG. 2. FIG. 2 is a flowchart illustrating the operation permission authentication processing performed by the operation permission authentication device 100. The processing illustrated in the flowchart in FIG. 2 is executed, for example, when the driver performs a starting operation (for example, an operation of pushing a start button of the autonomous driving) for the autonomous driving at the driver's seat of the vehicle subject to the operation permission authentication processing.

As illustrated in FIG. 2, as S10, the operation permission authentication ECU 10 of the operation permission authentication device 100 determines whether or not the driver's license is read by the card reader 1. If the driver's license is read (YES in S10), the operation permission authentication ECU 10 makes the process proceed to S12. When the driver's license is not read within a certain period of time (NO in S10), the operation permission authentication ECU 10 makes the process proceed to S28.

In S12, the operation permission authentication ECU 10 acquires the driver qualification information on the driver using the driver qualification information acquisition unit 11. The driver qualification information acquisition unit 11 acquires the driver qualification information on the driver based on the driver's license information read by the card reader 1. The authentication unit 15 determines that the driver has the driver qualification for the vehicle based on the driver qualification information on the driver.

In S14, the operation permission authentication ECU 10 acquires the biological information on the driver of the vehicle using the biological information acquisition unit 12. The biological information acquisition unit 12 acquires the biological information on the driver of the vehicle. The biological information acquisition unit 12 acquires the biological information on the driver based on the face image of driver imaged by the driver monitor camera 2, the weight information on the driver measured by the seat sensor 3, and the fingerprint information on the driver detected by steering contact sensor 4. An order of the processing items in S12 and S14 is not limited thereto, and S12 and S14 may be processed in parallel.

In S16, the operation permission authentication ECU 10 determines whether or not the driver is the autonomous driving permitted person using the authentication unit 15. The authentication unit 15 performs the above-described determination based on the biological information on the driver acquired by the biological information acquisition unit 12 and the biological information on the autonomous driving permitted person stored in the storage unit 5. If it is determined that the driver is not the autonomous driving permitted person (NO in S16), the operation permission authentication ECU 10 makes the process proceed to S28. If it is determined that the driver is the autonomous driving permitted person (YES in S16), the operation permission authentication ECU 10 makes the process proceed to S18.

In S18, the operation permission authentication ECU 10 determines whether or not the tutorial for the autonomous driving is unnecessary using the tutorial necessity determination unit 13. The tutorial necessity determination unit 13 performs the above-described determination based on the biological information on the driver acquired by the biological information acquisition unit 12 and the student data of the tutorial students stored in the student data storage unit 6. If it is determined that it is necessary for the driver to take the tutorial (NO in S18), the operation permission authentication ECU 10 makes the process proceed to S28. If it is determined that it is unnecessary for the driver to take the tutorial (YES in S18), the operation permission authentication ECU 10 makes the process proceed to S20.

If it is determined that it is necessary for the driver to take the tutorial, the operation permission authentication ECU 10 may request the driver to take the tutorial for the autonomous driving using the notification unit 14. If the driver takes the tutorial for the autonomous driving via the HMI 8, the operation permission authentication ECU 10 makes the process proceed to S20.

In S20, the operation permission authentication ECU 10 notifies the driver of the fact that it is unnecessary to take the tutorial using the notification unit 14 (the result of determination performed by the tutorial necessity determination unit 13). The notification unit 14 notifies the driver of the fact that it is unnecessary to take the tutorial by image display, audio output, or the like via the HMI 8.

In S22, the operation permission authentication ECU 10 checks whether or not the passcode input is set using the authentication unit 15. If the passcode input is not set (NO in S22), the operation permission authentication ECU 10 makes the process proceed to S30. If the passcode input is not set (YES in 822), the operation permission authentication ECU 10 makes the process proceed to S24.

In S24, the operation permission authentication ECU 10 requests the driver to input the passcode using the authentication unit 15. The authentication unit 15 makes the request by at least one of the image display and the audio output via the HMI 8.

In S26, the operation permission authentication ECU 10 determines whether or not the passcode is input using the authentication unit 15. If the passcode is not input within a certain period of time (NO in 826), the operation permission authentication ECU 10 makes the process proceed to S28. The operation permission authentication ECU 10 does not recognize that the passcode is input if an incorrect passcode is input. If the passcode is input (YES in S26), the operation permission authentication ECU 10 makes the process proceed to S30.

In S28, the operation permission authentication ECU 10 notifies the driver of a fact that the operation of the autonomous driving is not permitted, using the notification unit 14. If it is determined as NO in S18, the notification unit 14 notifies the driver of the fact that the operation of the autonomous driving is not permitted, together with the notification of the fact that it is necessary for the driver to take the tutorial (the result of determination performed by the tutorial necessity determination unit 13). Thereafter, the operation permission authentication ECU 10 ends the current operation permission authentication processing.

In S30, the operation permission authentication ECU 10 notifies the driver of the operation permission for the autonomous driving using the notification unit 14. In S32, the operation permission authentication ECU 10 authenticates the operation permission for the autonomous driving of the driver using the authentication unit 15. The operation permission authentication ECU 10 transmits the operation permission signal for the autonomous driving to the autonomous driving ECU 9 using the authentication unit 15.

### Operational Effects of the Operation Permission Authentication Device

In the operation permission authentication device 100 according to the present embodiment describe above, not only the driver qualification information on the driver but also the biological information on the driver is acquired from the result of measurement of seat sensor 3 and steering contact sensor 4, and then, the operation permission for the autonomous driving is authenticated based on the result of collation with the biological information on the autonomous driving permitted person. Therefore, according to the operation permission authentication device 100, even if the occupant is misidentified due to lending/borrowing of the driver's license, by referring to the result of collating with the biological information, it can be avoided to give an operation permission for the autonomous driving to improper occupants that are not autonomous driving permitted persons, and thus, it is possible to appropriately authenticate the operation permission for the autonomous driving.

In addition, according to the operation permission authentication device 100, if it is determined by the tutorial necessity determination unit 13 that it is necessary for the driver to take the tutorial for the autonomous driving, the notification unit 14 can notify the driver of the fact that it is necessary to take the tutorial for the autonomous driving. Therefore, it is possible to prevent the driver from using autonomous driving of the vehicle without fully understanding the autonomous driving.

In addition, according to the operation permission authentication device 100, if it is determined that it is necessary for the driver to take the tutorial for the autonomous driving, the driver is not permitted to operate the autonomous driving until completion of the tutorial. Therefore, it can be avoided to give the operation permission for the autonomous driving to the occupant who doesn't fully understand the autonomous driving.

In addition, according to the operation permission authentication device 100, the necessity for the occupant to take the tutorial for the autonomous driving is determined based on the version upgrade information on the tutorial. Therefore, the driver can appropriately know that it is necessary to take the tutorial for the autonomous driving due to the version upgrade of the tutorial.

As above, a preferred embodiment of the present disclosure is described above, the present disclosure is not limited to the above-described embodiment. The present disclosure can be implemented in various forms resulting from various modifications and improvements based on the knowledges of those who are skilled in the art in addition to the embodiment described above.

The operation permission authentication device 100 is not necessarily mounted on the vehicle, but may be provided in a server that can communicate with the vehicle capable of autonomous driving. In this case, the operation permission authentication ECU 10 illustrated in FIG. 1 corresponds to at least a part of the server. The server is configured as a computer including, for example, equal to or more than one CPUs, RAM and ROM, input devices such as a keyboard and a mouse, storage devices such as a semiconductor memory, a data transmission/reception device such as a network card, and the like.

The operation permission authentication device 100 does not need to necessarily acquire the driver qualification information from the driver's license. The operation permission authentication device 100 does not need to necessarily include the card reader 1, but may acquire the driver qualification information using a method other than the card reader 1.

Instead of the driver's license, the operation permission authentication device 100 may perform the personal authentication of the driver using a personal ID number card or the like that can specify an individual person or a personal identification information electronically issued by the public organization or the like. In this case, the driver qualification information acquisition unit 11 can acquire the driver qualification information on the individual person by referring the information on the individual person to the public organization or the like via the wireless network. For the personal authentication, the biological information on the driver acquired by the biological information acquisition unit 12 may be used. The personal authentication may be performed using a face image of the driver imaged by the driver monitor camera 2.

The operation permission authentication device 100 may essentially require a driver qualification to register as an autonomous driving permitted person. In this case, when the driver is determined to be an autonomous driving permitted person by the collating of the biological information, the operation permission authentication device 100 may acquire the driver qualification information on the driver while assuming that the driver has a driver qualification. Even if the driver qualification essentially is required to register the an autonomous driving permitted person, the operation permission authentication device 100 may request the driver for the driver qualification information at the time of starting the autonomous driving for the first time after getting in the vehicle.

The biological information does not need to necessarily include the face image of the driver. In this case, the operation permission authentication device 100 does not need to include the driver monitor camera 2.

The biological information may include any one of the weight information and the fingerprint information (or the vein information) on the driver. The operation permission authentication device 100 does not need to necessarily include both the seat sensor 3 and the steering contact sensor 4, but may include only one of them.

The operation permission authentication device 100 may use another contact sensor instead of the steering contact sensor 4. The position of the contact sensor is not particularly limited as long as the position can be touched by the hand or finger of the driver. The contact sensor may be provided on the armrest of the driver's seat, may be provided on the dashboard, or may be provided inside the door at the driver's seat side. Strictly speaking, the contact sensor does not need to come in contact with the hand or finger of the driver, but the fingerprint or the vein may be scanned by light or the like by bringing the hand or finger of the driver close to the contact sensor.

Student data does not need to necessarily include the information on the version of the tutorial taken by the students. In this case, if the driver has taken the tutorial for the autonomous driving at least once in the past, the tutorial necessity determination unit 13 may determine that it is unnecessary to take the tutorial for the autonomous driving. On the other hand, if the driver has never taken tutorial for the autonomous driving in the past, the tutorial necessity determination unit 13 determines that it is necessary to take the tutorial for the autonomous driving.

The operation permission authentication device 100 does not need to necessarily determine the necessity of taking the tutorial for the autonomous driving. In this case, the operation permission authentication device 100 does not need to include the student data storage unit 6 and the tutorial necessity determination unit 13. In addition, the notification unit 14 does not need to have the function of notifying the driver of the result of determination performed by the tutorial necessity determination unit 13. When it is determined that the driver is an autonomous driving permitted person having a driver qualification, the operation permission authentication device 100 in this case can authenticate the operation permission for the autonomous driving. If the operation permission authentication device 100 does not determine the necessity of taking the tutorial for the autonomous driving, the processing in S18 in the flowchart illustrated in FIG. 2 can be omitted.

The operation permission authentication device 100 does not need to necessarily have the function of setting the passcode input. In this case, the processing items in S20 to S24 in the flowchart illustrated in FIG. 2 can be omitted.

What is claimed is:

1. An operation permission authentication device configured to perform authentication for operation permission for autonomous driving of a vehicle, the device comprising:
a storage unit configured to store biological information on an autonomous driving permitted person;
a driver qualification information acquisition unit configured to acquire driver qualification information on an occupant on a driver's seat of the vehicle;
a biological information acquisition unit configured to acquire biological information on the occupant based on a result of measurement performed by a seat sensor provided in the driver's seat or a contact sensor provided against the drivers seat; and
an authentication unit configured to authenticate whether or not to permit the occupant to operate the autonomous driving of the vehicle based on the driver qualification information on the occupant acquired by the driver qualification information acquisition unit and a result of collation between the biological information on the autonomous driving permitted person stored in the storage unit and the biological information on the occupant acquired by the biological information acquisition unit.

2. The operation permission authentication device according to claim 1, further comprising:
a student data storage unit configured to store student data of tutorial students for the autonomous driving;
a tutorial necessity determination unit configured to determine a necessity for the occupant to take the tutorial based on the biological information on the occupant acquired by the biological information acquisition unit and the student data of the tutorial students stored in the student data storage unit; and
a notification unit configured to notify the occupant of a result of determination performed by the tutorial necessity determination unit.

3. The operation permission authentication device according to claim 2,
wherein the authentication unit is configured not to permit the operation of the autonomous driving until the occupant completes taking the tutorial if it is determined by the tutorial necessity determination unit that it is necessary for the occupant to take the tutorial for the autonomous driving.

4. The operation permission authentication device according to claim 2,
wherein the tutorial necessity determination unit is configured to determine the necessity for the occupant to take the tutorial based on the result of collation between the biological information on the autonomous driving permitted person stored in the storage unit and the biological information on the occupant acquired by the biological information acquisition unit, the student data of the tutorial students stored in the student data storage unit, and version upgrade information on the tutorial.

5. The operation permission authentication device according to claim 3,
wherein the tutorial necessity determination unit is configured to determine the necessity for the occupant to take the tutorial based on the result of collation between the biological information on the autonomous driving permitted person stored in the storage unit and the biological information on the occupant acquired by the biological information acquisition unit, the student data of the tutorial students stored in the student data storage unit, and version upgrade information on the tutorial.
